(19) United States
(12) Patent Application Publication
(10) Pub. No.: US 2024/0382380 A1
(43) Pub. Date: Nov. 21, 2024

(54) APPARATUS AND METHOD FOR FEEDING CAPSULES

(71) Applicant: I.M.A. INDUSTRIA MACCHINE AUTOMATICHE S.P.A., Ozzano dell’Emilia, (BO) (IT)

(72) Inventor: Massimo RIBANI, Ozzano dell'Emilia, (BO) (IT)

(21) Appl. No.: 18/689,995

(22) PCT Filed: Sep. 23, 2022
(86) PCT No.: PCT/IB2022/059026

§ 371 Date: Mar. 7, 2024

(30) Foreign Application Priority Data
Sep. 27, 2021 (IT) 102021000024605

(51) Int. Cl. A61J 3/07

(52) U.S. Cl. CPC A61J 3/074; A61J 2200/70

(57) ABSTRACT

A feeding apparatus includes a hopper for a plurality of capsules, and a feeding conduit for conveying the capsules from the hopper towards a transfer device of a filling machine in a single row along a feeding direction. The feeding apparatus also includes a sensor device for detecting a reciprocal position between a lid and a body of each capsule while passing through the feeding conduit and thus whether each capsule has a correct first orientation between the lid and the body or a wrong second orientation opposite to the first orientation, and an orientation arrangement positioned downstream of the sensor device and configured to rotate by 180°, around a rotation axis, each capsule which is oriented according to the wrong second orientation, and to pass through without rotating each capsule which is oriented according to the correct first orientation.

The present invention concerns automatic machines for filling capsules or opercula or similar elements with pharmaceutical and food products, and in particular it refers to an apparatus and a method for feeding capsules to an automatic filling machine.

Various types of filling machines are known, which are arranged to fill capsules, in particular lid-body capsules made of hard gelatin, with pharmaceutical or food products in liquid form, in powder, granules, tablets, micro-tablets, pellets, etc.

The known filling machines typically comprise transfer means that move the capsules through the different operating stations.

Filling machines are known in which the transfer means comprise a transfer turret or wheel, rotating about a vertical axis and provided with seats suitable for receiving the capsules, and a plurality of operating stations arranged around the transfer turret to perform operations on the capsules. The transfer turret by rotating moves the capsules through said operating stations, which typically comprise a feeding station, one or more dosing stations, a capsule closing station and a reject station of non-compliant capsules.

In the feeding station there is provided a feeding apparatus that picks empty capsules from a magazine or hopper and, after having correctly oriented them, typically with the lid above the body with reference to a vertical feeding direction, inserts the capsules in the seats of the transfer turret. Suitable means open the capsules by separating the lids from the bodies.

One or more dosing stations dose respective products into the capsule bodies.

In the closing station, the lids are again coupled to the respective bodies so as to close and reassemble the dosed caps that are conveyed out of the filling machine.

In the reject station, non-compliant capsules are eliminated, for example because they have a double lid, or because they contain too much or too little product, as verified by a measurement of capsule weight that is carried out in a previous weighing station of the filling machine.

The feeding apparatus of the feeding station comprises one or more feeding conduits that are parallel to each other and almost vertical and that draw the capsules from an overlying magazine or hopper, in which the capsules lie in bulk form, and convey the capsules to the seats of the transfer turret. Each feeding conduit allows a plurality of capsules arranged aligned on top of each other to form a single row to go down by gravity. Blocking means allow one single capsule at a time exiting from the respective feeding conduit and entering the underlying seat of the transfer turret.

The number of feeding conduits is equal to the number of seats that are provided in the transfer turret sector which is positioned at the feeding station.

Orientation means are associated with each feeding conduit to orient the capsules so that they are inserted into the corresponding seats typically with the lid up and the body down.

Orientation means are known that comprise for each feeding conduit a horizontal pusher element and a vertical pusher element which act on the capsule which remains blocked inside the conduit at a section narrowing thereof. More precisely, the width of the conduit is slightly lower than the width of the capsule lid which, in the absence of external forces, remains thus blocked. However, due to the slight interference thus created and the elasticity of the material (hard gelatin) of which the capsule is made, the capsule can be easily rotated and then moved inside the conduit in the underlying seat of the transfer turret by the horizontal pusher element, which acts in a direction almost orthogonal to the conduit, and by the vertical pusher element, which acts inside the conduit. The shape of abutment portions of horizontal and vertical pusher elements allows each capsule to be rotated so that it is inserted into the seat of the transfer turret with the lid up and the body down.

Capsule feeding apparatuses for filling machines provided with such orientation means are described for example in documents US2011/0146843 and WO2013/168086.

Document DE 102004004357 discloses a machine for filling hard gelatin capsules with a pharmaceutical powder product that comprises a hopper, suitable for containing a plurality of empty capsules, a feeding conduit for sequentially conveying the capsules from the hopper to an underlying capsule holder element and capsule orientation means for correctly orienting the capsules. The orientation means include a rotating drum provided with a radial through recess suitable for receiving one capsule at a time from the feeding conduit. In particular, the feeding conduit comprises a first oblique descending channel, which allows the descent by gravity of one capsule at a time and which opens into a second horizontal channel in which the capsule stops to be then pushed by a horizontal pusher inside the radial recess of the rotating drum. The rotating drum is rotated by 90° clockwise or counter-clockwise based on the initial orientation of the capsule detected by a sensor. In this way, suitably rotated, the drum releases each capsule with the required orientation into an underlying vertical conduit which leads to the capsule holder element.

An object of the present invention is to improve the known feeding apparatuses arranged to feed with capsules, or similar elements, filling machines.

Another object is to provide a compact and not bulky feeding apparatus having simple and reliable structure and operation.

A further object is to manufacture a feeding apparatus that allows detecting any defective capsules coming from a hopper.

In a first aspect of the invention there is provided a feeding apparatus associable with a filling machine according to claim 1.

In a second aspect of the invention there is provided a method for feeding capsules according to claim 10.

The invention can be better understood and implemented with reference to the attached drawings which illustrate an exemplary and non-limiting embodiment thereof, in which:

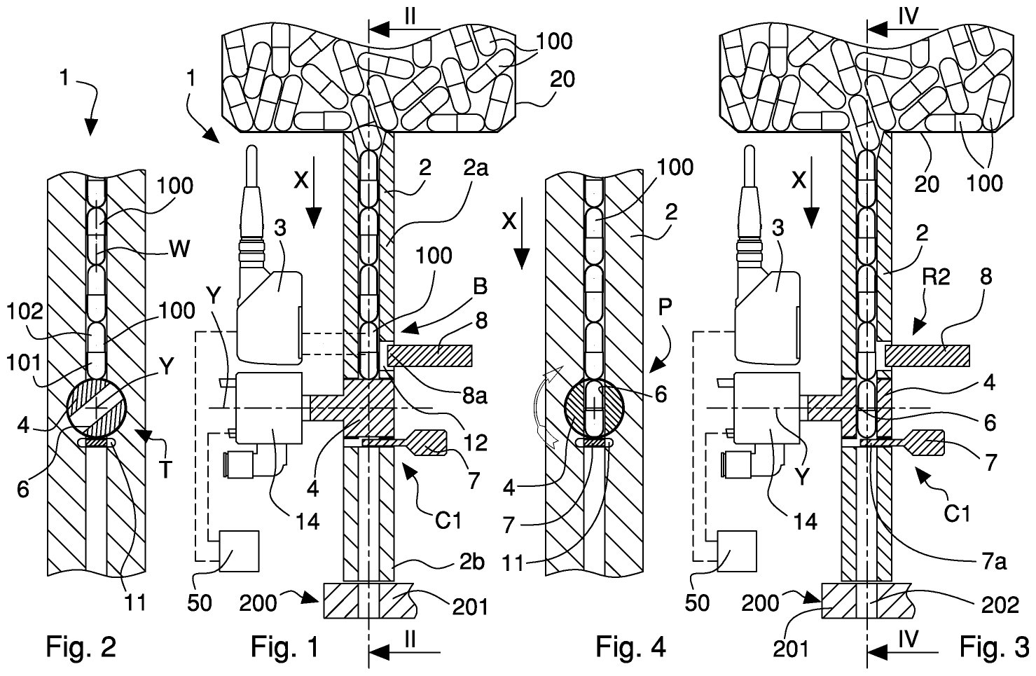

FIG. 1 is a schematic section of the feeding apparatus of the invention in a first operating step;

FIG. 2 is a section along line II-II of FIG. 1;

FIG. 3 is a section like the one of FIG. 1 illustrating the feeding apparatus in a second operating step;

FIG. 4 is a section along line IV-IV of FIG. 3;

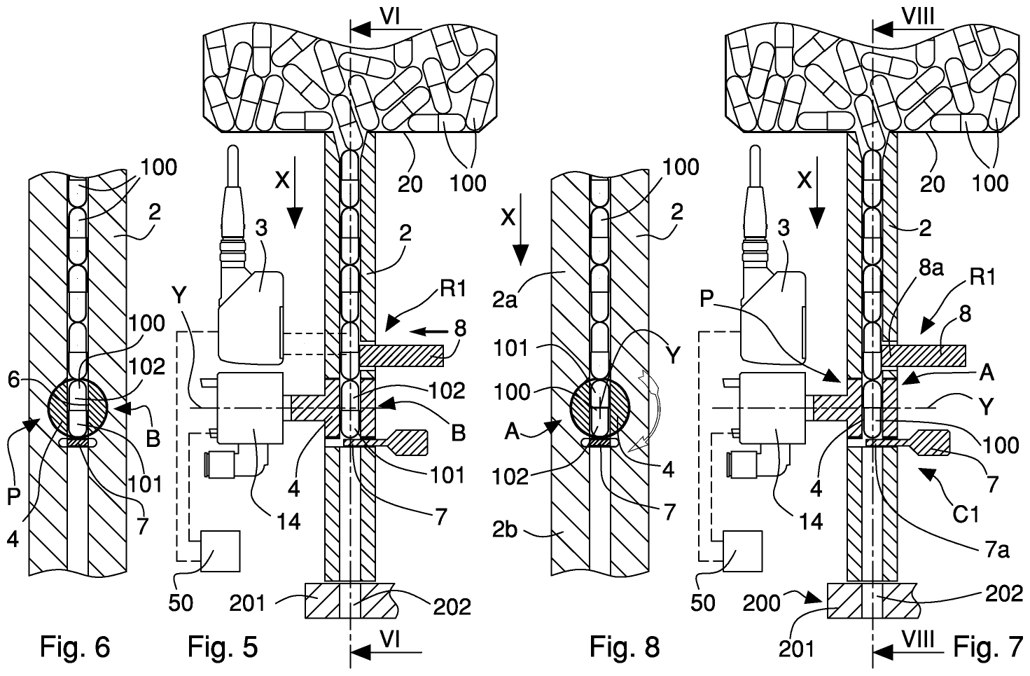

FIG. 5 is a section like the one of FIG. 1 illustrating the feeding apparatus in a third operating step;

FIG. 6 is a section along line IV-IV of FIG. 5;

FIG. 7 is a section like the one of FIG. 1 illustrating the feeding apparatus in a fourth operating step;

FIG. 8 is a section along line VIII-VIII of FIG. 7;

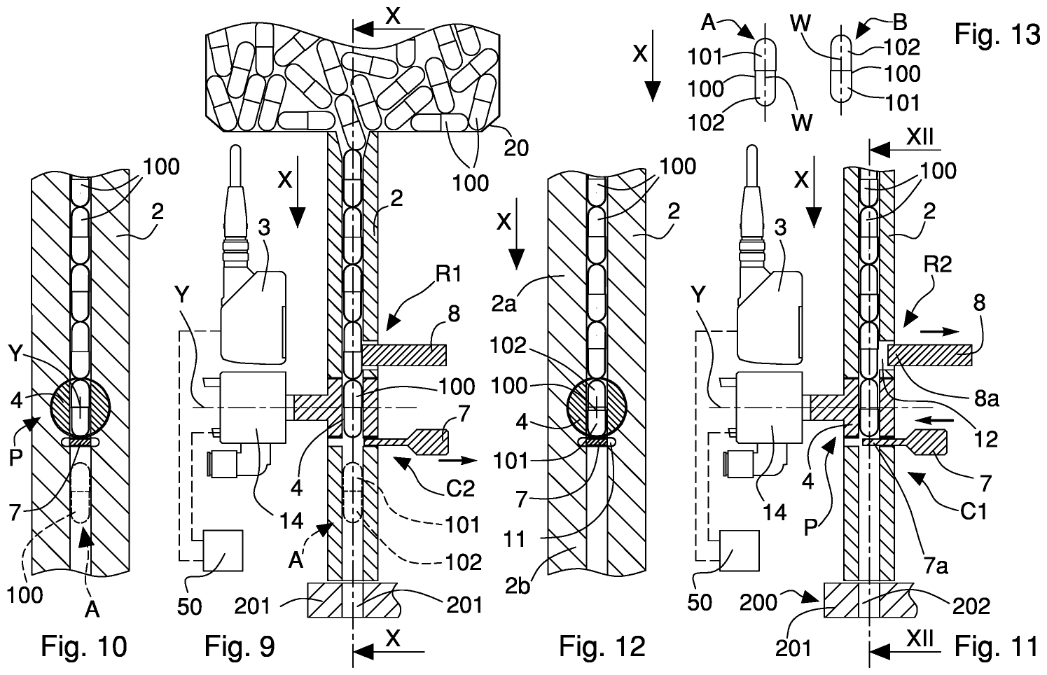

FIG. 9 is a section like the one of FIG. 1 illustrating the feeding apparatus in a fifth operating step;

FIG. 10 is a section along line X-X of FIG. 9;

FIG. 11 is a section like the one of FIG. 1 illustrating the feeding apparatus in a sixth operating step;

FIG. 12 is a section along line XII-XII of FIG. 11;

FIG. 13 is a front view of two capsules fed by the feeding apparatus of the invention respectively arranged with a first orientation and a second orientation with reference to a movement direction.

With reference to FIGS. 1 to 12, a feeding apparatus 1 according to the invention is schematically illustrated that is associable with a filling machine 200 in order to provide transfer means 201 thereof with capsules 100, in particular made of hard gelatin, formed by a lid 101 and a body 102.

The transfer means 201 comprise, for example, a transfer wheel or turret of a known type, provided with seats 202 suitable for receiving capsules 100 from the feeding apparatus 1.

The feeding apparatus 1 comprises a container or hopper 20 suitable for containing a plurality of capsules 100, at least one feeding conduit 2 for taking the capsules 100 from the hopper 20 and conveying them towards the transfer means 201, the capsules 100 aligned one after the other in contact along a feeding direction X to form a single row. More precisely, the feeding direction X is almost vertical and the capsules 100 are arranged in the feeding conduit 2 with a respective longitudinal axis W (axis of symmetry of the capsule along the dimension of greater length) parallel to the feeding direction X and can freely slide, in particular go down, by gravity along the feeding conduit 2 from the hopper 20 to the transfer means 201.

The feeding apparatus 1 further comprises sensor means 3 associated to the feeding conduit 2 and configured to detect an orientation A, B of the capsules 100 within the feeding conduit 2. More precisely, the sensor means 3 are configured to detect a reciprocal position between the lid 101 and the body 102 of each capsule 100 while passing through the feeding conduit 2, in order to detect whether each capsule 100 has a predefined first orientation A between the lid 101 and the body 102 with respect to the feeding direction X, which is considered correct, or a second orientation B, opposite to the first orientation, which is instead considered wrong.

The capsules 100 inside the hopper 20 are in fact inserted in the feeding conduit 2 with random orientation, i.e. with the bodies 102 facing the transfer means 201, i.e. downwards, with the first orientation A or with the lids 101 facing the transfer means 201, i.e. downwards, with the second orientation B.

Typically, the orientation of capsules 100 required in the filling machines is the first orientation A with the bodies 102 facing downwards to allow an easier detachment (and subsequent coupling) of the lids 101.

To this end, the feeding apparatus 1 also comprises orientation means 4 positioned downstream of sensor means 3 with respect to the feeding direction X and associated to the feeding conduit 2 and configured to receive and house one at a time the capsules 100 located inside the feeding conduit 2 and then rotate by 180° about a rotation axis Y, which is substantially orthogonal to the feeding direction X, each capsule 100 that has been detected by the sensor means 3 moving oriented according to the wrong second orientation B, and to be passed through without rotating by the capsules 100 that have been detected by the sensor means 3 moving oriented according to the correct first orientation A. In this way, all the capsules 100 are oriented according to the first correct orientation A when they reach the underlying transfer means 201.

The feeding conduit 2 comprises a first section 2a, positioned directly upstream of the orientation means 4, and a second section 2b, positioned between the orientation means 4 and the transfer means 201, the first section 2a and second section 2a being vertically arranged, in particular along the feeding direction X.

The orientation means 4 comprise an orientation element, having a substantially cylindrical shape, transversely fit into the feeding conduit 2 and rotatable about the rotation axis Y. The orientation element 4 is provided with a transverse through seat 6, in particular almost orthogonal to rotation axis Y, and arranged vertically aligned when receiving a capsule 100 from the first section 2a of the feeding conduit 2, in particular when said orientation element 4 is rotated in a passage position P. The through seat 6 is dimensioned to house a single capsule 100.

The feeding apparatus further comprises blocking means 7, positioned adjacent to, and downstream of, the orientation means 4, with reference to the feeding direction X and more precisely to a movement direction of the capsules 100 along the feeding conduit 2, and insertable in the second section 2b of feeding conduit 2 in order to block the passage of the capsules 100, in particular to retain a capsule 100 inside the through cavity 6 of orientation element 4 that is arranged in the passage position P.

The blocking means comprise a blocking element 7 provided with a flat end portion 7a adapted to be inserted into a transverse groove 11 made in the second section 2b of the feeding conduit 2, adjacent to, and under, the orientation means 4. In particular, the transverse groove 11 is orthogonal to the feeding direction X.

The blocking element 7 is moved linearly by respective actuator means, of known type and not illustrated in the figures, between a blocking position C1 (FIG. 1) in which the blocking element is partially inserted in the transverse groove 11 with the end portion 7a, and an opening position C2 (FIG. 9), in which the blocking element is disengaged from the feeding conduit 2 and allows the passage of the capsule 100.

The feeding apparatus further comprises stopping means 8 positioned adjacent to, and upstream of, the orientation means 4, with reference to the feeding direction X and more precisely to the movement direction of the capsules 100 along the feeding conduit 2, and insertable in the first section 2a of the feeding conduit 2 to abut and stop a capsule 100, preventing the insertion thereof in the orientation means 4, in particular in the through cavity 6 of the orientation element 4.

The stopping means comprise a stopping element 8 provided with a respective end portion 8a adapted to be inserted in a lateral opening 12 made in the first section 2a of the feeding conduit 2 adjacent to and above the orientation means 4. The stopping element 8 is linearly moved by respective actuator means, of known type and not illustrated in the figures, between an abutment position R1 (FIG. 5), in which said stopping element 8 is partially inserted in the lateral opening 12 in order to abut and stop with the respective end portion 8a a capsule 100, and a disengagement position R2 (FIG. 1), in which said stopping element 8 is disengaged from the feeding conduit 2 and allows the passage of the capsule 100.

The sensor means 3 are positioned adjacent to, and upstream of, the orientation element 4, in particular to detect a first orientation A or a second orientation B of the capsule 100 blocked in the feeding conduit 2 by the stopping means 8.

The sensor means 3 comprise, for example, an optical sensor capable of detecting, in addition to the orientation of the capsules 100, possible defects thereof, in particular capsules 100 provided with two lids 101 coupled to the same body 102.

The feeding apparatus 1 comprises a control unit 50 connected to sensor means 3 and to driving means 14 of the orientation means 4 and configured to control said driving means 14 based on signals sent by the sensor means 3 and relating to a detected orientation (first orientation A or second orientation B) of a capsule 100. The control unit 50 also controls the actuator means of blocking means 7 and stopping means 8.

The control unit can also be the control unit of the filling machine 200.

The driving means 14 comprise a rotary motor of known type, for example electric or pneumatic motor, connected to the orientation element 4 and arranged to rotate the orientation element by 180° about the rotation axis Y.

In a variant of the invention not illustrated in the figures, the feeding apparatus 1 comprises a plurality of feeding conduits 2, in particular parallel to each other, respective sensor means 3 and orientation means 4 being associated with each feeding conduit. The feeding conduits 2, fed by the same hopper 20, can be arranged aligned according to one or more rows.

The operation of the feeding apparatus 1 of the invention associated with a filling machine 200 for capsules 100 provided with transfer means 201 (to transfer the capsules through the several operating stations not illustrated of the filling machine 200) provides in a first initial step to arrange the orientation means 4 associated with the feeding conduit 2 of the capsules 100 in a stopping position T, so as to block in the feeding conduit 2 the capsules 100 positioned upstream of the orientation means 4 and coming from a hopper 20, to move the blocking means 7 in the blocking position C1 in order to block the feeding conduit 2 downstream of the orientation means 4 and to detect with sensor means 3 a first orientation A or a second orientation B of a capsule 100 that is blocked in the feeding conduit 2, in particular that abuts the orientation means 4.

In a second step, the orientation means 4 are rotated by the driving means 14 about the rotation axis Y in the passage position P to allow the capsule 100 adjacent to and abutting the orientation means 4 to be inserted in the through cavity 6 of the orientation means (FIGS. 3 and 4).

In a third step, the stopping means 8 are moved into the abutment position R1 in order to block in the feeding conduit 100 a capsule 100 adjacent to and upstream of the orientation means 4 and the sensor means 3 are activated to detect a first orientation A or a second orientation B of said blocked capsule 100 (FIGS. 5 and 6).

In a fourth step, the orientation means 4 are either rotated by 180° about the rotation axis Y if the capsule 100 contained in the through cavity 6 has the second orientation B, so as to arrange the capsule with the first orientation A or they are not rotated, but maintained fixed in the passage position P, if the capsule 100 already has the first orientation A (FIGS. 7 and 8).

In a fifth step, the blocking means 7 are moved into the opening position C2 so as to open the feeding conduit 2 and allow the capsule 100 arranged in the first configuration A to leave the orientation means 4 and go down towards transfer means 201 (FIGS. 9 and 10).

In a sixth step, the blocking means 7 are moved in the blocking position C1 to block the feeding conduit 2 downstream of orientation means 4 and the stopping means 8 are moved into the disengagement position R2 in order to release the capsule 100 that can be inserted in the orientation means 4, in particular in the through cavity 6 of orientation element 4.

The third, fourth, fifth and sixth steps are then repeated for each of the capsules 100 coming from the hopper 20.

Thanks to the feeding apparatus 1 of the invention, it is therefore possible to feed a filling machine 200 with capsules 100 having the correct orientation, in particular the first orientation A in which the body 102 of the capsule is facing downwards, towards the transfer means 201 of the filling machine 100. The sensor means 3 allow, in fact, to detect the orientation of each capsule 100 inside the feeding conduit 2 in such a way as to allow the orientation means 4 to be activated in rotation and to overturn, i.e. to rotate by 180°, one at a time all the capsules 200 coming from the hopper 20 and having a wrong orientation (the second orientation B).

Since detection of the orientation of capsules 100 and rotation of the orientation means 4 take place in a very short time, the feeding apparatus 1 of the invention also allows to feed filling machines having high production rates.

The feeding apparatus 1 of the invention is also particularly compact and not bulky and has a simple and reliable structure and operation. The orientation means 4 comprise in fact a single cylindrical-shaped orientation element, which is fit into the feeding conduit 2 between a first and a second section 2a, 2b thereof and is provided with a transverse through seat 6 suitable for receiving and house one capsule at a time. The orientation element 4 is directly actuated, in particular rotated by 180°, when necessary, by driving means 14, comprising a rotary motor of known type, for example electric or pneumatic motor, having small size and limited cost.

The sensor means 3 also allow to identify possible defective capsules coming from the hopper 20, for example capsules 100 provided with two lids 101 coupled to a same body 102. In this way, these defective capsules can be rejected in the filling machine before being filled with the product or excluded from the filling, avoiding waste of dosed product. The method according to the invention for feeding with capsules 100, which are formed by a lid 101 and a body 102, transfer means 201 of a filling machine 200, comprises the steps of:
arranging a hopper 20 suitable for containing a plurality of capsules 100;
arranging at least one feeding conduit 2 configured to convey the capsules 100 from the hopper 20 towards the transfer means 201 of the filling machine 200 in a single row aligned along a feeding direction X;
detecting by means of sensor means 3 a reciprocal position between lid 101 and body 102 of each capsule 100 while passing through the feeding conduit 2, in order to detect whether each capsule 100 has a predefined first orientation A between the lid 101 and the body 102 with respect to the feeding direction X, which is considered correct, or a second orientation B, opposite to the first orientation A, which is instead considered wrong;
arranging orientation means 4 associated with the feeding conduit 2 and comprising a through seat 6 that is sized to be passed through by the capsules 100;
arranging the orientation means 4 with the through seat 6 that is vertical; and
rotating by 180°, by means of orientation means 4 in particular rotated in a passage position P, about a rotation axis Y, which is substantially orthogonal to the feeding direction X, each capsule 100 that has been detected by the sensor means 3 moving oriented according to the wrong second orientation B; or
allowing advancing, without rotating, through the through seat 6 of orientation means 4 each capsule 100 that has been detected by the sensor means 3 moving oriented according to the correct first orientation A;
   so that all the capsules 100 are oriented according to the correct first orientation A when they reach the transfer means 201, wherein the feeding conduit 2 comprises a first section 2a, positioned directly upstream of the orientation means 4, and a second section 2b, positioned between orientation means 4 and transfer means 201, the first section and second section 2a, 2b being vertically aligned.

The method further comprises:
arranging stopping means 8 associated with the feeding conduit 2, adjacent to and upstream of the orientation means 4 with reference to the feeding direction X and configured to abut and block advancement of capsules 100;
moving the stopping means 8 in an abutment position R1 in order to block a capsule 100 in the feeding conduit 2; and
detecting by means of sensor means 3 a first orientation A or a second orientation B of the capsule 100.

The method also comprises:
arranging blocking means 7 adjacent to and downstream of orientation means 4, with reference to the feeding direction X, and insertable in the second section 2b of the feeding conduit 2 in order to block the passage of capsules 100, in particular in order to retain a single capsule 100 inside the orientation means 4;
moving the blocking means 7 in an opening position C2 so as to open the feeding conduit 2 downstream of orientation means 4 and allow the capsule 100 exiting the orientation means 4 and to go down towards the transfer means 201.

The method further comprises:
moving the blocking means 7 in a blocking position C1 so as to block the feeding conduit 2 downstream of orientation means 4; and
moving the stopping means 8 in a disengagement position R2 so as to release the capsule 100 and to allow the orientation means 4 to receive it.

The method comprises rotating by 180° the orientation means 4 about an almost orthogonal rotation axis Y and said feeding direction X, in particular the feeding direction being substantially vertical.

It is also provided to arrange the capsules 100 coming from the hopper 100 in the feeding conduit 2, in particular with random orientation, and with a respective longitudinal axis W parallel to the feeding direction X. The capsules 100 are arranged with the first orientation A wherein the respective bodies 102 face the transfer means 201 and with the second orientation B wherein the respective lids 101 face the transfer means 201.

The method further comprises detecting by means of sensor means 3 possible defects of the capsules 100, in particular capsules comprising two lids 101 coupled to the same body 102. According to the method, the capsules 100 reach the orientation means 4 by falling down vertically along the first section 2a of the feeding conduit 2.

1-13. (canceled)

14. A feeding apparatus of a filling machine for feeding capsules formed by a lid and a body, comprising:
a hopper suitable for containing a plurality of capsules;
at least one feeding conduit for conveying the capsules from said hopper towards a transfer system of said filling machine in a single row aligned along a feeding direction;
a sensor device associated to said feeding conduit and configured to detect a reciprocal position between the lid and the body of each capsule while passing through said feeding conduit, in order to detect whether each capsule has a predefined first orientation between the lid and the body with respect to the feeding direction which is considered correct, or a second orientation, opposite to the first orientation, which is instead considered wrong; and
an orientation arrangement located downstream of sensor device with respect to the feeding direction and associated to said feeding conduit;
wherein said orientation arrangement is configured:
to rotate by 180° about a rotation axis, substantially orthogonal to said feeding direction, each capsule which has been detected by the sensor device moving oriented according to the wrong second orientation, and
to be passed through without rotating by each capsule which have been detected by the sensor device moving oriented according to the correct first orientation,
so that all the capsules are oriented according to the correct first orientation when they reach the transfer system, said feeding conduit comprising a first section positioned directly upstream the orientation arrangement and a second section positioned between said orientation arrangement and said transfer system, said first section and second section being arranged vertically aligned.

15. The feeding apparatus according to claim 14, wherein said orientation arrangement comprises an orientation element, having a substantially cylindrical shape, fit into said feeding conduit and rotatable about said rotation axis, said orientation element comprising a through seat, which is substantially orthogonal to said rotation axis, arranged vertically aligned when receiving the capsule from said first section and sized to house a single capsule.

16. The feeding apparatus according to claim 14, comprising a blocking arrangement positioned adjacent to, and downstream of, said orientation arrangement, with reference to said feeding direction, and insertable in said second section of said feeding conduit in order to block the passage of said capsules to retain a single capsule within said orientation arrangement.

17. The feeding apparatus according to claim 14, comprising a stopping arrangement positioned adjacent to, and upstream of, said orientation arrangement with reference to said feeding direction and configured to abut and stop advancement of capsules.

18. The feeding apparatus according to claim 17, wherein said sensor device are positioned upstream of said stopping arrangement with reference to said feeding direction.

19. The feeding apparatus according to claim 17, wherein said stopping arrangement is partially inserted into a lateral opening made on said first section of said feeding conduit and configured mobile between an abutment position to block the capsule falling down, and a disengagement position to allow the capsule moving.

20. The feeding apparatus according to claim 14, wherein said at least one feeding conduit is a plurality of feeding conduits arranged parallel to each other, each feeding conduit being associated with a respective sensor device and a respective orientation arrangement.

21. The feeding apparatus according to claim 14, wherein said sensor device are configured to detect possible defects of said capsules.

22. The feeding apparatus according to claim 14, comprising a control unit connected to said sensor device and to a driving device of said orientation arrangement, said control unit being configured to control said driving device based on signals sent by said sensor device relating to orientation of each capsule.

23. A method for feeding capsules formed by a lid and a body to a transfer system of a filling machine, comprising:
arranging a hopper suitable for containing a plurality of capsules;
arranging at least one feeding conduit configured to convey the capsules from said hopper towards said transfer system of said filling machine in a single row aligned along a feeding direction;
detecting by a sensor device a reciprocal position between the lid and the body of each capsule while passing through the feeding conduit, so as to detect whether each capsule has an established first orientation between the lid and the body with respect to the feeding direction, which is considered correct, or a second orientation, opposite to the first orientation, which is instead considered wrong;
arranging an orientation arrangement associated with said feeding conduit and comprising a through seat sized to be passed through by the capsules;
wherein the method further comprises:
arranging said orientation arrangement with the through seat that is vertical; and
rotating by 180° by means of said orientation arrangement about a rotation axis, which is substantially orthogonal to said feeding direction, each capsule which has been detected by the sensor device moving oriented according to the wrong second orientation; or
allowing advancing without rotating, through said through seat, each capsule that has been detected by the sensor device moving oriented according to the correct first orientation;
so that all the capsules are oriented according to the correct first orientation when they reach the transfer system, wherein said feeding conduit comprises a first section positioned directly upstream of the orientation arrangement and a second section positioned between said orientation arrangement and said transfer system, said first section and second section being arranged vertically aligned.

24. The method according to claim 23, comprising arranging said capsules coming from said hopper in said feeding conduit with a respective longitudinal axis parallel to said feeding direction, said capsules being arranged in said first orientation when their respective bottoms are facing said transfer system and in said second orientation when their respective lids are facing said transfer system.

25. The method according to claim 23, further comprising detecting by means of said sensor device possible defects of said capsules.

26. The method according to claim 23, wherein the capsules reach the orientation arrangement by falling down vertically along the first section.

27. The feeding apparatus according to claim 21, wherein said sensor device is of the optical type.
